(19) United States
(12) Patent Application Publication
(10) Pub. No.: US 2005/0276902 A1
(43) Pub. Date: Dec. 15, 2005

(54) Method for producing cooked rice having egg flavor

(75) Inventors: Fumihiko Sano, Gunma (JP); Tatuya Yamamoto, Gunma (JP); Kenji Tomita, Gunma (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: AJINOMOTO CO.,INC., Tokyo (JP)

(21) Appl. No.: 11/147,170

(22) Filed: Jun. 8, 2005

(30) Foreign Application Priority Data
Jun. 11, 2004 (JP) 2004-173335

(51) Int. Cl. A23L 1/32

(52) U.S. Cl. 426/614

(57) ABSTRACT

A method for producing a cooked rice having not only a composite flavor to be generated when an edible oil, an egg and cooked rice are simultaneously heated but also an egg flavor which is excellent in storage stability of the flavor. A mixture in which an egg liquid and an edible oil are mixed with each other is heated and foamed and, then, cooked rice is charged in the thus-foamed mixture and, thereafter, heat-cooked. It is preferable that the above-described mixture is a mixture in which, after an egg yolk liquid and an edible oil are mixed with each other, an egg white liquid or a whole egg liquid is further added. Further, in an egg content in the mixture, it is appropriate that an egg white component is in the range, based on 100 parts by weight of an egg yolk component, of from 10 to 200 parts by weight. Further, it is preferable that charging of the cooked rice is performed at the time a yield of an egg content deprived of an edible oil content in the mixture in a foamed state is 60 to 85%.

### TECHNICAL FIELD

The present invention relates to a method for producing cooked rice having an egg flavor and, particularly, to a method for producing cooked rice having an egg flavor which is excellent in storage stability of the egg flavor or an egg texture and suitable of being stored in a frozen state.

### BACKGROUND ART

When fried rice containing egg is cooked, ordinarily, since cooked rice or a liquid egg is heat-cooked together with edible oil immediately before eating, a specific favorable flavor originated in the egg is generated. However, since the thus-generated flavor is extremely unstable, when a large amount of the fried rice is cooked in an industrial scale or it is frozen and, then, stored, there has been a problem in that it is difficult to maintain the flavor and, accordingly, the flavor is deteriorated at the time of eating.

For this account, in ordinary fried rice to be produced in the industrial scale or the like, fried egg heat-cooked in advance by using the edible oil is added to the cooked rice or a flavor oil or a fragrant material is added to supplement the flavor. However, there has been a problem in that the fragrance to be generated is escaped from the fried rice produced by such production method as described above during storage and, accordingly, the fried rice comes to be short of the egg flavor. Further, since the edible oil, the egg and the cooked rice were not simultaneously heated, a composite fragrance was unable to be obtained or the fragrance was not absorbed by rice itself, to thereby generate the fragrance which lacks a sense of unity.

In order to solve these problems, a method in which the cooked rice is coated by an egg liquid which has not been heat-solidified and, then, frozen (see, for example, Japanese Unexamined Patent Publication No. 2000-60463, hereinafter referred to as Patent Document 1), another method in which the cooked rice is coated by the egg liquid which has been heat-solidified and, then, frozen (see, for example, Japanese Unexamined Patent Publication No. 2002-191304, hereinafter referred to as Patent Document 2), still another method in which raw rice is cooked by using egg cooking water containing an egg yolk, to thereby coating the cooked rice with the egg (see, for example, Japanese Unexamined Patent Publication No. 2002-281917, hereinafter referred to as Patent Document 3), even still another method in which the cooked rice is mixed with an edible oil, a liquid egg and an emulsifier and, then, heated (see, for example, Japanese Unexamined Patent Publication No. 2003-18968, hereinafter referred to as Patent Document 4) and the like have been proposed.

However, in the method as described in Patent Document 1, there has been a problem in that, when thawing was performed by using a microwave oven after storage in a frozen state, a fried egg flavor was unable to be obtained and, also, rice grains were stuck to one another. Further, in the methods as described in Patent Documents 2 and 4, since an edible oil and an egg were heated in a state in which they were mixed with cooked rice, quantity of heat was consumed in evaporating a moisture contained in the cooked rice, the egg is not sufficiently heated and, then, an egg flavor was not sufficiently exhibited and, as a result, the egg flavor was deteriorated to a great extent after the storage in the frozen state. Still further, on this occasion, when the rice grains are coated with the egg, there has been a problem in that an uneven attachment of an egg liquid or rough surfaces of the rice grains were generated. Even still further, in the method as described in Patent Document 3, there has been a problem in that the egg flavor was deteriorated after the storage in the frozen state.

Then, the present invention has an object to provide a method for producing cooked rice having not only a composite flavor to be generated when edible oil, an egg and cooked rice are simultaneously heated but also an egg flavor which is excellent in storage stability of the flavor.

### SUMMARY OF THE INVENTION

In order to solve the above-described problems, a method for producing cooked rice having an egg flavor according to the present invention comprises, in the order mentioned, the steps of heating a mixture of egg liquid and (an) edible oil(s) to foam the entire mixture; placing cooked rice in said foaming mixture; and cooking resulting mixture.

Further, the mixture is prepared by mixing egg yolk liquid and the edible oil(s), and then adding thereto egg white liquid and/or whole egg liquid; egg component in the mixture comprises 10 to 200 parts by weight of egg white component per 100 parts by weight of egg yolk component; the step of placing the cooked rice is carried out at a stage at which yield of egg component in the mixture excluding the edible oil(s) is 60% to 85%. The method further comprises the step of freezing the cooked rice after the step of cooking the mixture.

According to the method for producing the cooked rice having the egg flavor of the present invention, by foaming the mixture in which the egg liquid and the edible oil are mixed with each other by heating before the cooked rice is charged, it is possible to fully exhibit the egg flavor. Further, by charging the cooked rice into the mixture in the foamed state and, then, heat-cooking the resultant mixture, the cooked rice having a composite flavor generated by simultaneously heating the edible oil, the egg and the cooked rice can be obtained.

Particularly, by using the mixture in which, after an egg yolk liquid and the edible oil are previously sufficiently mixed to allow the egg yolk liquid to be dispersed in the edible oil as fine particles, an egg white liquid or a whole egg liquid is added to the resultant dispersion and mixed, a flavor of fried egg can be drawn out to a greater extent.

Further, by performing the charging of the cooked rice at the time a yield of the egg content in the mixture in the foamed state is 60% or more, a texture and the flavor of the egg can be drawn out in an optimum state. And, as for a weight ratio of the egg yolk component and the egg white component, by allowing the egg white component to be in the range, based on 100 parts by weight of the egg yolk component, of from 25 to 200 parts by weight and, particularly, by allowing the egg yolk component to be larger compared with an ordinary whole egg, the flavor of the egg can be drawn out to a great extent. Frozen cooked rice prepared by freezing the thus-obtained cooked rice having the egg flavor still retains a sufficient egg flavor even when thawed by using a microwave oven after being stored in a frozen state.

### MODE FOR CARRYING OUT THE INVENTION

According to the present invention, the term “egg liquid” as used herein means not only a whole egg liquid of, for example, a whole egg of before being heat-denatured, a frozen whole egg, a sugar-added whole egg, a salt-added whole egg, but also various types of liquid articles each in a state in which egg yolk and egg white are mixed with each other and, also, means to include only a whole egg, an article in which a whole egg is added with the egg yolk or the egg white and another article in which the egg yolk and the egg white are mixed with each other without using the whole egg. As for the egg yolk, egg yolk before heat-denatured, a frozen egg yolk, a sugar-added egg yolk, a salt-added egg yolk and the like can be used. As for the egg white, egg white before heat-denatured, a frozen egg white, egg white restored by adding water to a dried egg white and the like can be used. Such whole eggs as described above can be used either each individually or in mixtures of two or more types. Similarly, the egg yolk and the egg white can be used respectively either each individually or in mixtures of or more types. In each of these egg liquids comprising the whole egg, the egg yolk and the egg white, condiments, an emulsifier and the like can optionally be added. Further, when the cooked rice in a state of after heat-cooked is stored in a frozen state, in order to suppress denaturing in a frozen state, it is preferable that saccharides, starches or the like are optionally added to the egg liquid.

As for the weight ratio of the egg yolk component and the egg white component in the egg liquid, it is preferable that the egg white component is in the range, based on 100 parts by weight of the egg yolk component, of from 10 to 200 parts by weight, particularly of from 25 to 150 parts by weight and, still particularly, of from 40 to 100 parts by weight. When an amount of the egg yolk component to be contained in the egg liquid becomes large, the flavor of the egg in the cooked rice after being produced tends to be intensified; however, when it is unduly large, the texture thereof may sometimes become soft.

The edible oil to be used in the present invention is not particularly limited and rape oil, soybean oil, peanut oil, butter, sesame oil, olive oil, lard and the like can be used either each individually or in mixtures of two or more types. Further, as for the butter or the like which is solid at ambient temperature, it is necessary to heat it in advance to be in a liquid form before it is added with the egg liquid. Further, it is possible to optionally add condiments to these edible oils.

It is preferable that the egg liquid and the edible oil are sufficiently mixed with each other such that the egg liquid, particularly the egg yolk component, is finely dispersed in the edible oil. Further, after the egg yolk liquid is mixed in the edible oil while being gradually added therein to be in a state in which the egg yolk component is sufficiently dispersed in the edible oil, the resultant mixture is added with the egg white liquid or a whole egg liquid and mixed there with and, accordingly, a mixture in which the egg yolk component is allowed to be in a more favorably dispersed state in the edible oil can be obtained.

A mixing ratio of the egg liquid and the edible oil can appropriately be set depending on conditions such as types of the cooked rice to be produced and presence or absence of freezing, strength of the egg flavor to be desired, properties of the egg liquid, a ratio of the egg yolk and the egg white, and types or properties of the edible oil; however, in a state in which such frozen fried rice or the like as is ordinarily sold commercially is produced, an amount of the egg liquid is appropriately in the range, based on 100 parts by weight, of from 50 to 400 parts by weight of the edible oil. On this occasion, when an amount of the edible oil is unduly small against the egg liquid, a state in which the egg liquid is sufficiently dispersed in the edible oil can not be prepared, while, when the edible oil is unduly large, the egg flavor is deteriorated.

The mixture of the egg liquid and the edible oil is charged in a heat-cooking apparatus such as a pot, a kettle or the like and, then, heated. A heating temperature on this occasion is approximately the same temperature as that in an ordinary frying process, for example, it suffices to charge the mixture of the egg liquid and the edible oil in the cooking apparatus which is heated at 180 to 230° C. in advance. At the time the mixture of the egg liquid and the edible oil is charged, in order to prevent the mixture from being scorched, it is preferable to coat a surface of the cooking apparatus to be heated with a small amount of the edible oil in advance. By heating the mixture of the egg liquid and the edible oil, a moisture contained in the egg liquid dispersed in the edible oil is vigorously boiled to form bubbles and, then, an entire body of the mixture is foamed with fine bubbles to be in a state in which an entire volume thereof becomes several times as large as an original one. It is preferable to appropriately stir the mixture during heating such that the entire body thereof comes in a homogeneously foamed state.

Next, the cooked rice is charged in the mixture in the foamed state and, then, heat-cooked. An amount of the cooked rice to be charged in the mixture varies depending on conditions such as an object of the cooked rice to be produced, a mixing ratio of the egg liquid and the edible oil in the mixture and the like and, accordingly, is not particularly limited and may be set to be approximately the same as in a case in which an ordinary fried rice or pilaf is produced. For example, in a relation with the edible oil in the mixture, the cooked rice is appropriately in an amount, based on 10 parts by weight of the edible oil, of from 50 to 300 parts by weight. When the amount of the cooked rice becomes small, a finished article becomes oily, while, when the amount of the cooked rice is unduly large, rice grains are stuck to one another, to thereby sometimes form agglomerates. Further, in a relation with the egg liquid in the mixture, the cooked rice is appropriately in an amount, based on 10 parts by weight of the egg liquid, of from 30 to 150 parts by weight. When an amount of the egg liquid is small, a sufficient egg flavor can not be obtained, while, when an amount of the egg liquid is unduly large, a finished article comes to be in a state like fried egg which is different from the cooked rice.

It is preferable to charge the cooked rice into the mixture in the foamed state, in a state in which an entire body of the mixture is in the foamed state, particularly, from immediately after to in such a short period of time as a few tens of seconds after the entire body of the mixture is foamed. A time duration of from a start of heating the mixture to a start of foaming varies depending on conditions such as a ratio of the egg liquid and the edible oil in the mixture, a ratio of the egg yolk component and the egg whit component in the egg liquid in the mixture and heating temperature, and foaming of the mixture is generated by firstly allowing a temperature of the entire body of the mixture to be increased by the start of heating and, then, allowing a moisture contained in the egg liquid to be heated and boiled.

On this occasion, when the time duration of from the start of heating to the start of foaming is long, the moisture is lost by evaporation in heating before the start of foaming without boiling and, then, the yield of the egg content deprived of the edible oil content in the mixture is deteriorated. At the same time, since the moisture is continuously lost even after the start of foaming, the yield is further deteriorated along the passage of time. By contrast, when the time duration of from the start of heating to the start of foaming is short, the moisture to be evaporated in heating before the start of foaming comes to be smaller and, then, the yield of the egg content is enhanced.

And, when the yield of the egg content deprived of the edible oil content in the foamed mixture comes to be less than 60%, the texture becomes hard, while, when the yield of the egg content is over 85%, the texture becomes soft. Therefore, it is preferable to charge the cooked rice when the yield of the egg content deprived of the edible oil content in the foamed mixture is 60% or more and, taking it into consideration that the moisture of the egg content is further lost by heat-cooking after the cooked rice is charged, it is particularly preferable to charge the cooked rice when the yield of the egg content is 75% or more. However, when the yield of the egg content is 85% or more, there is no problem so long as the yield of the egg content comes to be 85% or less by the subsequent heat-cooking.

Further, the yield of the egg content deprived of the edible oil content in the foamed mixture is a value determined by using a relation of (A−B)/C×100 (%), wherein A represents a weight of fried egg containing the edible oil after foaming by heating and immediately before the charging of the cooked rice; B represents a weight of the edible oil to be loaded; and C represents a weight of the liquid egg to be loaded.

The cooked rice charged in the mixture in the foamed state comes to be in a state in which an entire body thereof is wrapped in the mixture in the foamed state and, then, in a heat-cooking process which allows the cooked rice to be in a fully loose state by appropriately stirring, efficiently comes in contact with the egg content, particularly a flavor component and a fragrant component generated from the egg yolk component, in the mixture in a state in which a volume thereof is swollen by foaming in whole and a surface thereof is also expanded and, thereafter, the egg flavor enters into an inside of the rice grain, absorbed in the rice grain and, then, retained therein and, at the same time, an entire surface of each rice grain can be in a state in which it is covered by films of the oil and the fried egg. Further, an excess of the egg content becomes in a state of the fried egg which becomes, then, in a state of being dispersed in the rice grains. Heat-cooking after the charging of the cooked rice may be performed under an appropriate stirring condition in the same manner as in an ordinary frying operation and, also, it is possible to add various types of ingredients such as meat and vegetables and various types of seasonings such as salt and pepper either at the same time when the cooked rice is charged or during a subsequent heat-cooking.

In such a manner as described above, by charging the cooked rice in the mixture, being allowed to be in the foamed state by being heated, in which the egg liquid and the edible oil are mixed with each other and, then, heat-cooking the resultant mixture, since the egg can sufficiently be heated before the charging of the cooked rice, the flavor of the egg which is fried with the oil can fully be exhibited. Further, since the thus-exhibited flavor of the egg and the fragrance come to be in a state in which they are entrapped in bubbles generated in the entire body of the mixture, it is possible to efficiently absorb the egg flavor in the rice grains. Still further, since the entire surface of the rice grain is covered by the films of the oil and the fried egg, sticking of rice grains there among can be suppressed.

Under these circumstances, the cooked rice having a composite flavor to be generated when the edible oil, the egg and the cooked rice are simultaneously heated can be obtained. Further, even when the cooked rice having such egg flavor is changed into a frozen cooked rice by an ordinary freezing operation, the egg flavor is not much deteriorated during storage in a frozen state and, then, the cooked rice which is excellent in storage stability, has a sufficient egg flavor by thawing by using a microwave oven after the storage and contains fried egg excellent in texture can be eaten.

### DETAILED DESCRIPTION OF THE PREFERRED EMBODIMENTS

The invention is illustrated specifically below by referring to Comparative Examples and Examples.

Firstly, salad oil (trade name: CANOLA; manufactured by Ajinomoto Co., Inc.) was used as an edible oil, an influence which presence or absence of mixing the salad oil and an egg liquid before heating gave at the time of heating was confirmed and, also, an influence which the mixing method of salad oil and the egg liquid and a ratio of an egg yolk component and an egg white component in the egg liquid gave was confirmed. Further, as for a cooking apparatus, an IH heater (Model: KZ-PN1; manufactured by National) was used and, as a cooking container, a pot attached to the IH heater was used.

### COMPARATIVE EXAMPLE 1

50 g of salad oil was charged in a pot, heated to 180° C. by using “IH heating, strong” and, then, 30 g of a raw egg yolk and 70 g of a raw egg white in a state in which they were mixed by hand were charged in the pot and is, continuously, heated while stirring by using a spatula. Heating is stopped at the time a foam started to be generated and an entire volume (fried egg and oil) in the pot was recovered and weighed. A yield containing oil at the time of foaming and another yield of only an egg content deprived of the oil content were each calculated. Further, a texture and a flavor were evaluated by eating the thus-obtained fried egg. Still further, an appearance of the fried egg was also evaluated.

### COMPARATIVE EXAMPLE 2

The same operations were repeated as in Comparative Example 1 except that a mixing ratio of the raw egg yolk and the raw egg white was set to be 50 g of the raw egg yolk and 50 g of the raw egg white and, then, not only the yield is calculated, but also the texture, the flavor and the appearance were evaluated in the same manner as in Comparative Example 1.

### COMPARATIVE EXAMPLE 3

The same operations were repeated as in Comparative Example 1 except that a mixing ratio of the raw egg yolk and the raw egg white was set to be 70 g of the raw egg yolk and 30 g of the raw egg white and, then, not only the yield is calculated, but also the texture, the flavor and the appearance were evaluated in the same manner as in Comparative Example 1.

### COMPARATIVE EXAMPLE 4

The same operations were repeated as in Comparative Example 1 except that a mixing ratio of the raw egg yolk and the raw egg white was set to be 90 g of the raw egg yolk and 10 g of the raw egg white and, then, not only the yield is calculated, but also the texture, the flavor and the appearance were evaluated in the same manner as in Comparative Example 1.

### EXAMPLE 1

Firstly, 45 g of salad oil was added to an egg liquid in a state in which 30 g of a raw egg yolk and 70 g of a raw egg white were mixed with each other by hand and, then, sufficiently mixed, to thereby prepare a mixture of the egg liquid and the salad oil. Next, 5 g of salad oil was charged in a pot and, then, heated to 180° C. by using “IH heating: strong” and, thereafter, the above-described mixture of the egg liquid and the salad oil was charged in the pot and continuously heated while stirring by using a spatula. Heating is stopped at the time a foam started to be generated and, then, in the same manner as in Comparative Example 1, an entire volume (fried egg and oil) in the pot was recovered and weighed. A yield containing oil at the time of foaming and another yield of only an egg content deprived of the oil content were each calculated. Further, a texture and a flavor were evaluated by eating the thus-obtained fried egg. Still further, an appearance of the fried egg was also evaluated.

### EXAMPLE 2

Firstly, 30 g of a raw egg yolk and 45 g of salad oil were sufficiently mixed with each other and, then, 70 g of a raw egg white was added to the resultant mixture and, thereafter, sufficiently mixed, to thereby prepare a mixture of the egg liquid and the salad oil. Next, in a same manner as in Example 1, 5 g of salad oil was charged in a pot and, then, heated to 180° C. by using “IH heating: strong” and, thereafter, the above-described mixture was charged in the pot and continuously heated while stirring by using a spatula. Heating is stopped at the time a foam started to be generated and, then, an entire volume in the pot was recovered and weighed. A yield containing oil at the time of foaming and another yield of only an egg content deprived of the oil were each calculated. Further, a texture and a flavor were evaluated by eating the thus-obtained fried egg. Still further, an appearance of the fried egg was also evaluated.

### EXAMPLE 3

The same operations were repeated as in Example 1 except that a mixing ratio of the raw egg yolk and the raw egg white was set to be 50 g of the raw egg yolk and 50 g of the raw egg white and, then, not only the yield is calculated, but also the texture, the flavor and the appearance were evaluated in the same manner as in Example 1.

### EXAMPLE 4

The same operations were repeated as in Example 2 except that a mixing ratio of the raw egg yolk and the raw egg white was set to be 50 g of the raw egg yolk and 50 g of the raw egg white and, then, not only the yield is calculated, but also the texture, the flavor and the appearance were evaluated in the same manner as in Example 2.

### EXAMPLE 5

The same operations were repeated as in Example 1 except that a mixing ratio of the raw egg yolk and the raw egg white was set to be 70 g of the raw egg yolk and 30 g of the raw egg white and, then, not only the yield is calculated, but also the texture, the flavor and the appearance were evaluated in the same manner as in Example 1.

### EXAMPLE 6

The same operations were repeated as in Example 2 except that a mixing ratio of the raw egg yolk and the raw egg white was set to be 70 g of the raw egg yolk and 30 g of the raw egg white and, then, not only the yield is calculated, but also the texture, the flavor and the appearance were evaluated in the same manner as in Example 2.

### EXAMPLE 7

The same operations were repeated as in Example 2 except that a mixing ratio of the raw egg yolk and the raw egg white was set to be 90 g of the raw egg yolk and 10 g of the raw egg white and, then, not only the yield is calculated, but also the texture, the flavor and the appearance were evaluated in the same manner as in Example 2.

In each of Examples and Comparative Examples, when a state at the time of the start of foaming was observed, in each of Comparative Examples, foaming was generated only in a peripheral portion of the egg, while, in each of Examples, the foam was generated from entire body of the mixture charged in the pot and, then, a height of the mixture in the pot came to be in such a swollen state as being 2 to 3 times that at the time of charging. Operational conditions and the results in Comparative Examples 1 to 4 and Examples 1 to 5 are shown in Table 1 as a whole.

TABLE 1

| | No. | | | | | | | | | | |
|---|---|---|---|---|---|---|---|---|---|---|---|
| | Comparative Example | | | | Example | | | | | | |
| | 1 | 2 | 3 | 4 | 1 | 2 | 3 | 4 | 5 | 6 | 7 |
| Salad oil (charging to pot) (g) | 50 | 50 | 50 | 50 | 5 | 5 | 5 | 5 | 5 | 5 | 5 |
| Salad oil (mixing with egg) (g) | — | — | — | — | 45 | 45 | 45 | 45 | 45 | 45 | 45 |
| Egg yolk liquid (g) | 30 | 50 | 70 | 90 | 30 | 30 | 50 | 50 | 70 | 70 | 90 |
| Egg white liquid (g) | 70 | 50 | 30 | 10 | 70 | 70 | 50 | 50 | 30 | 30 | 10 |
| Pre-mixing condition | (1) | (1) | (1) | (1) | (2) | (3) | (2) | (3) | (2) | (3) | (3) |
| IH setting | Strong | Strong | Strong | Strong | Strong | Strong | Strong | Strong | Strong | Strong | Strong |
| Charging temperature (° C.) | 180 | 180 | 180 | 180 | 180 | 180 | 180 | 180 | 180 | 180 | 180 |
| Time before start of foaming | 7:00 | 2:30 | 1:40 | 1:00 | 4:30 | 3:00 | 4:10 | 2:50 | 3:00 | 1:40 | 1:00 |
| (minute:second) | | | | | | | | | | | |
| Yield at the time of foaming | 57% | 80% | 93% | 96% | 72% | 77% | 77% | 85% | 84% | 89% | 91% |
| (inclusive of oil) | | | | | | | | | | | |
| Yield at the time of foaming | 36% | 70% | 89% | 94% | 58% | 66% | 66% | 78% | 83% | 77% | 86% |
| (exclusive of oil) | | | | | | | | | | | |
| Foaming state | Partially foamed | | | | Entirely foamed | | | | | | |
| Texture | Scorched | ◯ | ◯ | Soft | Hard | ◯ | ◯ | ◯ | ◯ | ◯ | Soft |
| Flavor | X | Δ | Δ | ◯ | Δ | ◯ | Δ | ◯◯ | ◯ | ◯◯ | ◯◯ |
| Fried egg state | Large | Large | Large | Large | Small | Small | Small | Small | Small | Small | Small |

(1): No mixing.
(2): A mixture of an egg yolk liquid and an egg white liquid is mixed in a salad oil.
(3): After an egg yolk liquid and a salad oil are mixed with each other, an egg white liquid is added to the resultant mixture and mixed.
Texture: ◯: good.
Flavor: ◯◯: very good, ◯: good, Δ: not so good, X: bad

From these results, by mixing the egg liquid and the salad oil (edible oil) in advance and, then, heating the resultant mixture, it has been found that the entire body of the mixture came to be in a state of foaming by heating of a short period of time and the recovered fried egg in Examples appeared to be in small pieces compared with Comparative Examples. Further, by mixing the egg yolk liquid and the salad oil in advance and, then, adding the egg white liquid and mixing the resultant mixture, it has been found that the start of foaming became earlier. Still further, it has been found that, in each case, when the yield of the egg content at the time of foaming became 60% or less, the fried egg became unduly hard and, accordingly, the texture became deteriorated and, also, as the yield of the egg content is higher, the fired egg in a more fluffy state was obtained.

Subsequently, a difference of finished-up condition depending on the timing of charging the cooked rice was confirmed. Firstly, 10 g of a raw egg yolk and 9 g of salad oil were sufficiently mixed with each other and, then, 10 g of a raw egg white was added and, thereafter, sufficiently mixed, to thereby prepare a mixture of an egg liquid and salad oil. 1 g of salad oil is charged in a pot and heated to 180° C. by setting an IH heater to be “IH heating: middle” and, then, the above-described mixture was charged in the pot and, thereafter, heated while stirring by using a spatula. As a result, at the time 2 minutes 50 seconds has elapsed after the mixture was charged, foaming started from the entire body of the mixture.

### COMPARATIVE EXAMPLE 5

After one minute has passed since the mixture was charged but before foaming started therein, 160 g of cooked rice was charged in to the mixture and, then, heat-cooked until the cooked rice became in a loose state, to thereby produce fried rice having an egg flavor. An entire egg flavor and fried egg texture after the fried rice was completed was evaluated and, also, the thus-completed fried rice was frozen in a loose state by using dry ice and, then, after stored for one week at −18° C., the thus-frozen fried rice was thawed and heated by using a microwave oven. An entire egg flavor of the thus-thawed and heated fried rice and a texture of the fried rice were evaluated. Further, the same operations as before were separately repeated and, 1 minute after the mixture was charged in the pot, heating is stopped. An entire volume in the pot was recovered and weighed and, then, the yield containing the oil at the time of charging the cooked rice and the yield of only the egg content deprived of the oil were each calculated.

### COMPARATIVE EXAMPLE 6

The same operations as in Comparative Example 5 were repeated except that the timing of charging the cooked rice was set to be 5 minutes after the mixture was charged, namely, at the time 2 minutes and 10 seconds has passed since the foaming started and, then, in the same manner as before, the entire egg flavor and the texture of the fried egg each after the fried rice was completed and after the fried rice was stored for one week in a frozen state were each evaluated. Further, the yield containing the oil at the time of charging the cooked rice and the yield of only the egg content deprived of the oil were each calculated.

### EXAMPLE 8

The same operations as in Comparative Example 5 were repeated except that the timing of charging the cooked rice was set to be 3 minutes after the mixture was charged, namely, immediately after the foaming started (after 10 seconds) and, then, in the same manner as before, the entire egg flavor and the texture of the fried egg each after the fried rice was completed and after the fried rice was stored for one week in a frozen state were each evaluated. Further, the yield containing the oil at the time of charging the cooked rice and the yield of only the egg content deprived of the oil were each calculated.

Operational conditions and the results in Comparative Examples 5 and 6 and Example 8 are shown in Table 2 as a whole.

TABLE 2

| | Comparative | Comparative | |
|---|---|---|---|
| | Example 5 | Example 6 | Example 8 |
| Salad oil | 1 | 1 | 1 |
| (charging to pot) | | | |
| Salad oil | 9 | 9 | 9 |
| (mixing with egg) | | | |
| Egg yolk liquid (g) | 10 | 10 | 10 |
| Egg white liquid (g) | 10 | 10 | 10 |
| Cooked rice (g) | 160 | 160 | 160 |
| IH setting | Middle | Middle | Middle |
| Charging temperature (° C.) | 180 | 180 | 180 |
| Time for charging | One minute | 5 minutes | 3 minutes |
| of cooked rice | | | |
| Yield at the time of foaming | 92% | 70% | 85% |
| (inclusive of oil) | | | |
| Yield at the time of foaming | 88% | 55% | 75% |
| (exclusive of oil) | | | |
| After completion of fried rice | | | |
| Entire egg flavor | ◯ | ◯◯ | ◯◯ |
| Fried egg flavor | ◯ | X | ◯ |
| After thawing of frozen state | | | |
| (stored for one week at −18° C.) | | | |
| Entire egg flavor | X | ◯ | ◯ |
| Fried egg flavor | ◯ | X | ◯ |
| | Although the egg | Although a flavor | The egg flavor |
| | was finished-up | remains even after | is maintained |
| | in a fluffy state, | thawing the frozen | even after |
| | a flavor after | state, the fried | freezing, and |
| | thawing the frozen | egg is unduly hard. | the fried egg is |
| | state is weak. | | finished fluffy. |

Entire egg flavor: ◯◯: very good, ◯: good, X: bad
Fried egg flavor: ◯: good, X: bad

From the results, when the cooked rice before the foaming of the liquid egg was charged, it has been found that the flavor after thawing the frozen state became deteriorated. Further, when a long period of time has passed after the foaming and the cooked rice was charged in a state in which the yield of the egg became 60% or less, it has been found that the fried egg became unduly hard, to thereby deteriorate the texture. On the other hand, when the cooked rice was charged immediately after the foaming started, the egg flavor was strong and, further, a fluffy fried egg was obtained even after thawing the frozen state.

### INDUSTRIAL APPLICABILITY

According to the present invention, by heating the mixture of the egg liquid and the edible oil and by allowing a foam to be generated and, then, charging the cooked rice in the thus-foamed mixture and, then, heat-cooking the resultant mixture, the cooked rice having not only a composite flavor to be generated when the edible oil, the egg and the cooked rice are simultaneously heated but also an egg flavor which is excellent in storage stability of the flavor can be provided.

1. A method for producing cooked rice having egg flavor, comprising, in the order mentioned, the steps of heating a mixture of egg liquid and (an) edible oil(s) to foam the entire mixture; placing cooked rice in said foaming mixture; and cooking resulting mixture.

2. The process according to claim 1, wherein said mixture is prepared by mixing egg yolk liquid and said edible oil(s), and then adding thereto egg white liquid and/or whole egg liquid.

3. The process according to claim 1, wherein egg component in said mixture comprises 10 to 200 parts by weight of egg white component per 100 parts by weight of egg yolk component.

4. The process according to claim 1, wherein said step of placing said cooked rice is carried out at a stage at which yield of egg component in said mixture excluding said edible oil(s) is 60% to 85%.

5. The process according to claim 1, further comprising the step of freezing said cooked rice after said step of cooking the mixture.
